(19) United States
(12) Patent Application Publication
(10) Pub. No.: US 2014/0076011 A1
(43) Pub. Date: Mar. 20, 2014

(54) Interchangeable System of Cylinder Combination with Embedded Key in Door Lock (Side/Trunk) Equipped with Automobile Vehicle Free-Turning Anti-Theft Device

(71) Applicants: Homero de Andrade, Sao Paulo (BR); Jose de Jesus Pin, Sao Paulo (BR)

(72) Inventors: Homero de Andrade, Sao Paulo (BR); Jose de Jesus Pin, Sao Paulo (BR)

(73) Assignee: VALEO SISTEMAS AUTOMOTIVOS LTDA., Guarulhos (BR)

(21) Appl. No.: 13/816,916

(22) PCT Filed: Aug. 15, 2011
(86) PCT No.: PCT/BR2011/000282

§ 371 Date: Oct. 7, 2013

(30) Foreign Application Priority Data
Aug. 13, 2010 (BR) 1004246-6

(51) Int. Cl. E05B 65/12

(52) U.S. Cl. CPC E05B 77/44
USPC 70/490

(57) ABSTRACT

The present invention is directed to a free-turning anti-theft device assembled in a door lock, a characteristic translated into obtaining a first subcombination cylinder with key subcombination (S1) which is mounted on a second subcombination called free-turning anti-theft subcombination (S2), wherein the first can receive all kinds of specifications of cylinder (3) with key (ch), and accordingly the cylinder (3) is now included in its constructive concept, with a lock (12) positioned at the rear of the body (3a) of the cylinder (3), where in turn the convention rear part of this cylinder is separated and now forms the unprecedented cylinder terminal (4) which is mounted inside the free-turning anti-theft subcombination (S2), such that the lock (12) is of the fast lock kind, where its locking face (12d) is of the click kind, being raised by the action of a spring (13) also provided inside the cylinder (3), and compressed upon interference thereof with the inner wall of the intermediary shell (5), which acts in the definitive lock, when protruding and adjacent to its edge (5a).

### FIELD OF APPLICATION

The present invention refers to an inventive solution in interchangeable system of cylinder combination with embedded key in door lock of automobile vehicle, equipped with free-turning anti-theft device and its field of application is the automobile industry, which uses the celebrated “systemic assembly” technique, where the suppliers of countless items of the vehicle supply the mounted item to the assembler (be it a device, mechanism, electricelectronic systems, and the like).

### BACKGROUND OF THE INVENTION

In order to provide veracity to the context referred to in the introduction, there follows a brief explanation of the state of the art for automobile vehicle door locks with embedded free-turning anti-theft device, wherein a person skilled in the art will be able to recognize its limitative aspects, and then later discuss the advantages brought by introducing the unprecedented interchangeable system.

Concept of automobile vehicle door lock equipped with free-turning anti-theft device: the lock is fixed on the outer panel of the automobile vehicle side door or trunk lid, and its function is to execute the locking/unlocking in the look, where the free-turning anti-theft system is applied with desmodromic key, the constructive concept of which is based on the following components:
a cylinder, inside of which there is mounted a plurality of gorges, springs and a lock for these springs;
a lid, disposed on the front part of the cylinder, whereon the cover is mounted, this lid having a slit for inserting the door lock/unlock key;
an actuator component, or eccentric component, mounted on the rear part of the cylinder, jointly with a helical spring;
an intermediary shell, inside of which there is mounted the combination of cylinder components duly assembled and the actuator component; and also a helical spring,
an outer shell, receiving the assembly of the mounted inner shell and also adjacent to the outer wall of the intermediary shell and to the inner wall of this outer shell there is mounted the linear spring and lock combination of the free-turning anti-theft system, in the form of a pointed protrusion; and
a lever, mounted on the front end of the outer shell, where it receives the action of the displacement course caused by the permissive or furtive drive of the cylinder combination, actuator lid.
   Functional Concept of the Lock Door for an Automobile Vehicle, Equipped with Free-Turning Anti-Theft Device:

a. Normal working condition: when the correct key is inserted into the lid, all the gorges inside the cylinder are withdrawn and this cylinder can move in relation to its intermediary shell. When the cylinder moves, movement is transmitted to the actuator component and consequently to the lever.

b. Theft working condition: when an incorrect key is inserted or an attempt is made to break in, the gorges are not withdrawn, and there is retention between cylinder, gorges and intermediary shell. This retention causes the lock to be withdrawn and lets the combination of cylinder components, gorges, inner shell and actuator turn freely around the outer shell. Under theft conditions, when applying a torque of 1.5N·m, the system turns freely and the lock is not driven to unlock the doors or trunk lid. As the actuator does not generate movement for the lever, the center of the pin that drives the lever in the actuator is on the same shaft as the outer and intermediary shell, creating free turns, rendering the radial course movement of the lever unfeasible. If there is a theft condition where the components do not deteriorate, the lock will function normally when the correct key is inserted into the combination.

A survey of the state of the art reveals that the concept disclosed above is widely known. For a better understanding of this condition, it is pertinent to cite Brazilian utility model patent MU 7402472-8, entitled “ADJUSTABLE ROTOR LOCK”, originally filed in France on May 18, 1994, revealing a lock equipped with a gyratory rotor in the intermediary stator, itself being pivoting on a fixed body, equipped with locking organs (gorges) with the rotor and the intermediary stator to join them in rotation in the absence of a key, or in the presence of a non-conforming key, and to release the rotor after introducing a conforming key, and of the kind that has an index organ of the intermediary stator with respect to the fixed body carried out in the form of an arm disposed in a lengthways accommodation formed in the peripheral wall of the intermediary stator, characterized wherein the indexing arm is carried out in the form of a beam extending lengthways normally to occupy an indexing position and which can be elastically flexed to occupy a hidden position.

Critical analysis of the solutions in automobile vehicle door locks equipped with a free-turning anti-theft device: an in-depth study of this kind of solution for door locks and trunk lids, allows the affirmation that although it fulfills its primary objective, namely to prevent thieves from unlocking the door, it is possible to identify a series of design restriction aspects that lead to the generation of demand for the invention previously described in the introduction, where it is a consensus among technical experts in the field that the constructive concept embedded in this kind of solution makes it mandatory to assembly the entire combination, that is, the assembler receives the complete lock part with the cylinder and key already mounted on the body of the free-turning anti-theft device.

The above condition prevents the preliminarily identified demand from being met, this being the separate supply of the cylinder combination with key, thus truncating a contemporary and mandatory condition which seeks to meet the demands of the market and industrial logistics.

Notably in the division of safety systems is the interchangeable system for cylinder combination with key claimed, notably in the group of products spearheaded by the door and/or trunk lock product, and even more specifically its distinctive characteristics are consolidated when applied to locks equipped with the celebrated free-turning anti-theft system.

### SUMMARY OF THE INVENTION

The unprecedented interchangeable system of cylinder combination with key was idealized firstly bearing in mind the point of view wherein the client is the end consumer. In this condition, there is an explicit contemporary need for the automobile market to offer automobile vehicles that have great flexibility in the assembly of different items of the automobile vehicle, the fruit of the individualized specification generated by the consumers themselves.

In turn, when this same automobile industry is geared towards logistic aspects of assembly, costs, planning and production control, it needs to guarantee that its assembly line is as flexible as possible, with a large quantity of different items to be assembled, wherein said same items have differences in detail, rendering the logistical aspects of assembly even more critical as each vehicle has minor differences in specification.

Faced with the demand identified above of a marketing and industrial logistics nature, for the present invention the elected product, technically called “lock equipped with a free-turning anti-theft device” is applied to the structural model of doors and trunk lids of an automobile vehicle, wherein it should comprise the possibility for the assembler to opt for the assembly of all kinds of cylinders with keys, jointly with the free-turning anti-theft mechanism itself, whereby guaranteeing the mandatory flexibility in assembling the lock product for side doors and trunks with the most varied specifications, be they related to market or engineering.

Having defined the demand and paradigm for developing the invention, the applicant idealized the unprecedented interchangeable system of the cylinder combination with keys, wherein this cylinder is equipped with an unprecedented lock that guarantees the assembly and fixing to the receptacle of the intermediary shell component, and at its rear part it receives the modification in the sense that it is projected with fit-in and guide protrusions, which will be duly mounted on the unprecedented cylinder terminal component, which is nothing more than the reproduction of the rear part of the conventional cylinder, mounted preliminarily inside the outer shell.

From the point of view of the auto-parts industry, the design of the unprecedented interchangeable system of cylinder with key comprises the lock device which bears the celebrated industrial concept called “poka yoke” in the assembly of the cylinder.

Analogously, from an assembler's perspective, the assembly of the cylinder combination with key to the outer shell component also comprises the aforementioned industrial concept called “poka yoke”.

Further within the scope of the unprecedented condition of interchangeable assembly for all kinds of cylinder combinations with key, the applicant emphasizes the facility of the assembly procedure which converges excellence in quality and productivity.

Therefore, it is conclusive that the combination formed by the three “cylinder”+“lock”+“cylinder terminal” components can be understood as part of an object of practical use, translated by an automotive vehicle door lock equipped with free-turning anti-theft device, being susceptible of industrial application, guaranteeing improved productivity and assembly flexibility, with consequent gains in industrial logistics and marketing, meeting patentability requirements.

### BRIEF DESCRIPTION OF THE DRAWINGS

To complement the present description and to provide a better understanding of the characteristics of the present invention application, appended hereto is a set of drawings, where in an exemplary manner, though not limitative, there is a depiction of a preferred embodiment for the door lock of an automobile vehicle formed by the unprecedented cylinder with keys and free-turning anti-theft subcombination.

FIG. 1 is a plan view depiction of the cylinder with key subcombination and of the free-turning anti-theft subcombination immediately before its assembly;

FIG. 2 is a plan view depiction of the cylinder with key subcombination and of the free-turning anti-theft subcombination duly assembled;

FIG. 3 is a front view depiction of the cylinder with key subcombination and of the free-turning anti-theft subcombination duly assembled;

FIG. 4 is an exploded perspective view depiction of the cylinder with key subcombination and of the free-turning anti-theft subcombination reveals its component parts, highlighting the distinctive characteristics that consolidate the interchangeable system;

FIG. 5 is a perspective view depiction of the cylinder with key subcombination revealing its component parts, highlighting the distinctive characteristics that consolidate the interchangeable system;

FIG. 6 is an orthogonal “YY” perspective cut view depiction of the cylinder with key subcombination revealing its component parts, highlighting the distinctive characteristics that consolidate the interchangeable system;

FIG. 7 is a plan view depiction of the cylinder with key subcombination and of the free-turning anti-theft subcombination (in orthogonal “XX” cut) immediately prior to assembly;

FIG. 8 is a rear perspective view depiction of the cylinder with key subcombination and of the cylinder terminal component which is mounted on the free-turning anti-theft subcombination revealing its component parts, highlighting the distinctive characteristics that consolidate the interchangeable system; immediately before it is coupled upon assembly of the two subcombinations;

FIG. 9 is a rear perspective view depiction of the cylinder with key subcombination and of the cylinder terminal component which is mounted on the free-turning anti-theft subcombination revealing its component parts, highlighting the distinctive characteristics that consolidate the interchangeable system; immediately after its coupling upon assembly of the two subcombinations;

FIG. 10 is an orthogonal “AA” cut view depiction of the cylinder with key subcombination mounted to the free-turning anti-theft subcombination revealing its component parts, highlighting the distinctive characteristics that consolidate the interchangeable system;

FIG. 11 is an orthogonal “BB” cut view depiction of the cylinder with key subcombination mounted on the free-turning anti-theft subcombination revealing its component parts, highlighting the distinctive characteristics that consolidate the interchangeable system;

FIG. 12 is an orthogonal “CC” cut view depiction of the cylinder with key subcombination mounted on the free-turning anti-theft subcombination revealing its component parts, highlighting the distinctive characteristics that consolidate the interchangeable system;

FIG. 13 is a rear perspective view depiction of the cylinder with key subcombination mounted on the intermediary shell component of the free-turning anti-theft subcombination revealing its component parts, highlighting the distinctive characteristics of the definitive lock obtained.

### DETAILED DESCRIPTION OF THE INVENTION

In light of that set forth in the background of the art, the applicant idealized an “interchangeable system of the cylinder combination with embedded key in door lock (side/trunk) equipped with automobile vehicle free-turning anti-theft device”, the distinctive characteristic of which lies in providing said lock with two distinct combinations, namely:

1. a cylinder with key subcombination;

2. a free-turning anti-theft subcombination.

Inventive activity: in unprecedented fashion, the cylinder combination with key is mounted on the free-turning anti-theft assembly when the automobile vehicle is assembled, in detriment to the unique cylinder with key combination and its free-turning anti-theft device, which is characteristic of the systemist concept, the practical result of which provides advantages of a marketing and industrial logistics nature chiefly for the assembler.

Distinctive characteristic: bearing in mind the technological base that supports the door and trunk lock equipped with free-turning anti-theft device described in the background of the art, and to meet the requirement of inventive activity above, there is presented an inventive solution that reveals for the cylinder with key subcombination, a unique cylinder, the rear part of which is truncated and equipped with protrusions that fit into the new cylinder terminal component, which is mounted on the rear part of the intermediary shell.

In turn, to guarantee the assembly and locking of the cylinder with key subcombination on the free-turning anti-theft subcombination, the cylinder presents a second unique factor, which lies in providing an additional accommodation for the lock, wherein said lock is designed to follow a profile arrangement similar to the profile of the gorges elements, which however do not have the same function, this being exclusively a lock, which in turn has a locking face that passes through the extra slit defined on the rear part of the cylinder, when free from interference from the inner wall of the intermediary shell, and withdrawn adjacently to this slit when the inner wall interferes with this same shell, during the assembly procedure, where to guarantee the return movement to its original position, that is with a protruding face in relation to the extra slit, there is defined a helical spring. Lastly, this lock is designed such that its assembly and stabilization inside the cylinder is guaranteed by its support with the linear lock element, it is used to lock the conventional gorges.

Within the scope of the assembly process of the cylinder with key subcombination, it is supported by the celebrated ‘click’ type system, where the face of the lock embedded in the cylinder, as soon as it is free from interference from the inner wall of the intermediary shell, describes lifting movement in relation to the extra slit of the cylinder, returning to its original position, thereafter to interfere with the rear edge of this intermediary shell, thus preventing the cylinder with key subcombination from being disassembled.

The detailed description should be read and interpreted with reference to the drawings presented herein, where these are highly diagrammatic, representing a preferred embodiment of the interchangeable system of cylinder combination with embedded key in door lock (side/trunk) equipped with free-turning anti-theft device of automobile vehicle and are not intended to limit the scope of the invention, which is only limited by that set forth in the set of claims.

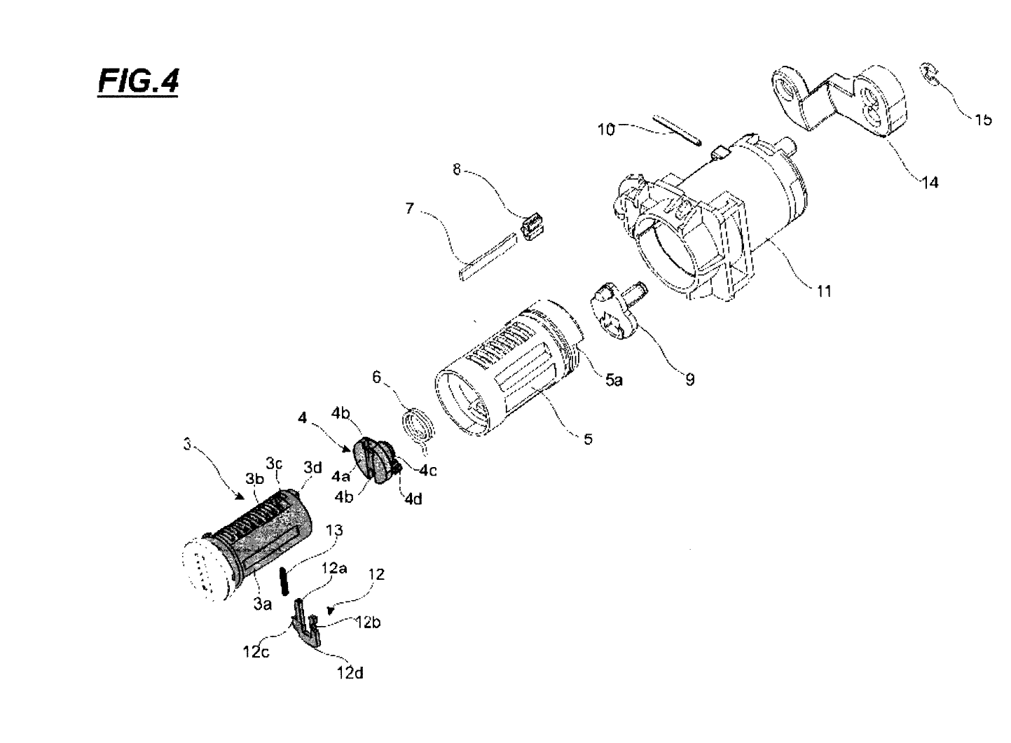

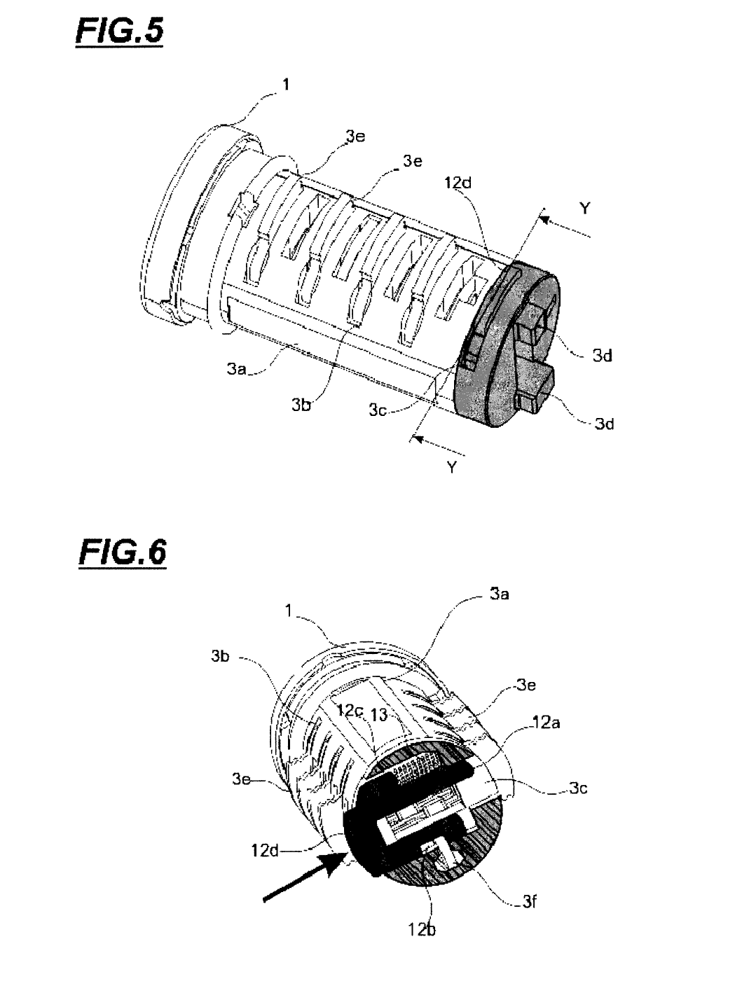

Technological basis: the applicant understands that it is appropriate to present a generic form of embodiment considered standard for the automobile vehicle door lock part equipped with free-turning anti-theft device, the constructive concept of which is formed by the component parts set forth in FIG. 4, namely:
a cylinder (3) formed by a body (3a) where longitudinally on its upper and lower parts there is defined a row of plurality of access slits (3b), and on the inside there is mounted a plurality of gorges (3e), see FIG. 5, springs (not referenced) and a lock for these springs (3f), see FIG. 6;
an intermediary shell (5), inside of which there is mounted the combination of cylinder components (3) duly assembled and the actuator component (9); and also a helical spring (6);
a helical spring (6), mounted on the rear part of the cylinder (3);
a linear spring (7) mounted on the outer part of the intermediary shell (5);
a free-turning lock (8) mounted on the outer part of the intermediary shell (5);
an actuator (9), or eccentric component, mounted on the rear part of the intermediary shell (5), jointly with the helical spring (6);
an assembly lock of the combination (10);
an outer shell (11) which receives the assembly of the intermediary shell (5) mounted and also adjacent to the outer wall of the intermediary shell (5) and to the inner wall of this outer shell (10) there is mounted the combination of linear spring (7) and lock (8) of the free-turning anti-theft system, in the form of a pointed protrusion;
a drive lever (14) mounted on the rear end of the outer shell (11), where it receives the action of the displacement course caused by the permissive or furtive drive of the cylinder combination (3), lid and actuator (9);
a lock pin (15).

### Inventive Activity:

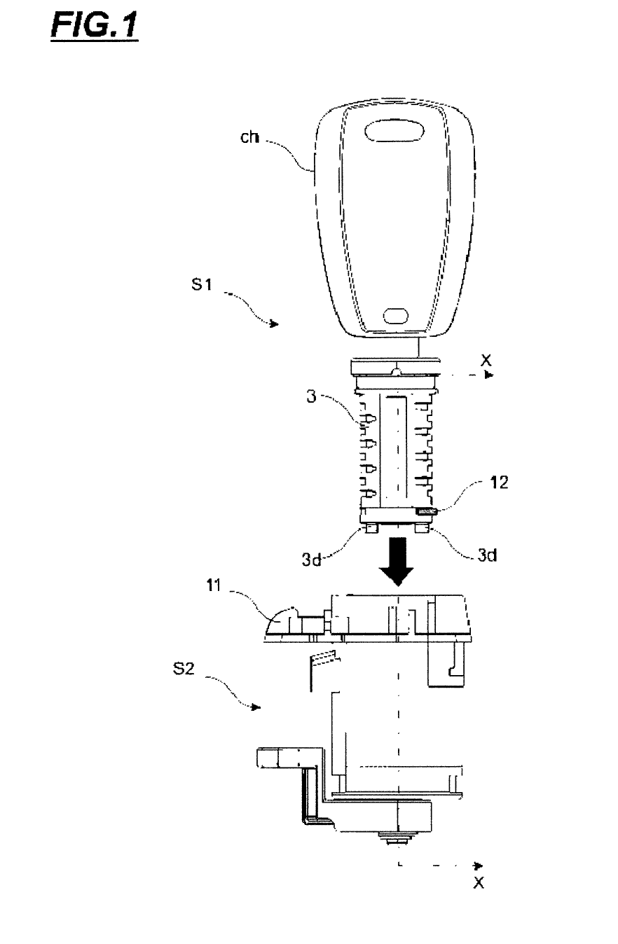

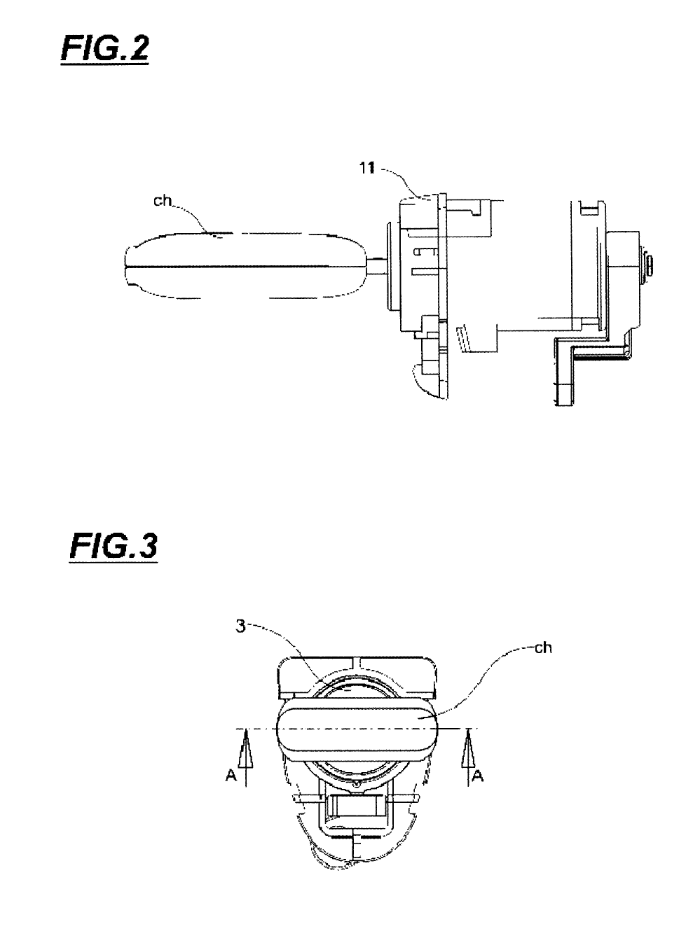

a. Cylinder with key subcombination (S1): as revealed in FIGS. 1, 4, 5 and 6 respectively, formed by a cylinder component (3) composed by a body (3a) where longitudinally, on its upper and lower parts there is defined a row of plurality of access slits (3b), and on the inside there is mounted a plurality of gorges (3e), see FIG. 5, springs (not referenced) and a linear lock (3f) for these springs, see FIG. 6 presents distinctive characteristic by having a truncated rear part equipped with fit-in protrusions (3d) that are coupled to the new cylinder terminal component (4), which is mounted on the rear part of the intermediary shell (5), also having a rear slit (3c) which guarantees the passage of the lock (12), guaranteeing the assembly and locking of the cylinder with key subcombination (S1) on the free-turning anti-theft subcombination (S2).

In turn, this lock (12) is designed to follow a profile arrangement similar to the profile of the gorges elements (3e), and there is defined a locking face (12d) that passes through the extra slit (3c) defined on the rear part of the cylinder (3), when free of interference from the inner wall of the intermediary shell (5), and withdrawn adjacently to this slit (3c) when the inner wall interferes with this same intermediary shell (5), during the assembly procedure, where to guarantee the return movement to its original position, that is with the locking face (12d) protruding in relation to the slit extra (3c), there is defined a helical spring (13) disposed in vertical position, where to guarantee the stability of the assembly of the combination of spring (13)+lock (12) on the side part of the body (12a) of this lock (12) a side protrusion (12c) said protrusion providing rest for the lower end of this spring (13) which in turn has its upper end limited by the upper wall of the inner cavity of the cylinder (3), as revealed in detail in FIGS. 6 and 11. Additionally, on the side opposite the side protrusion (12c) there is defined a chapel (12b) through which the linear lock (3f) passes.

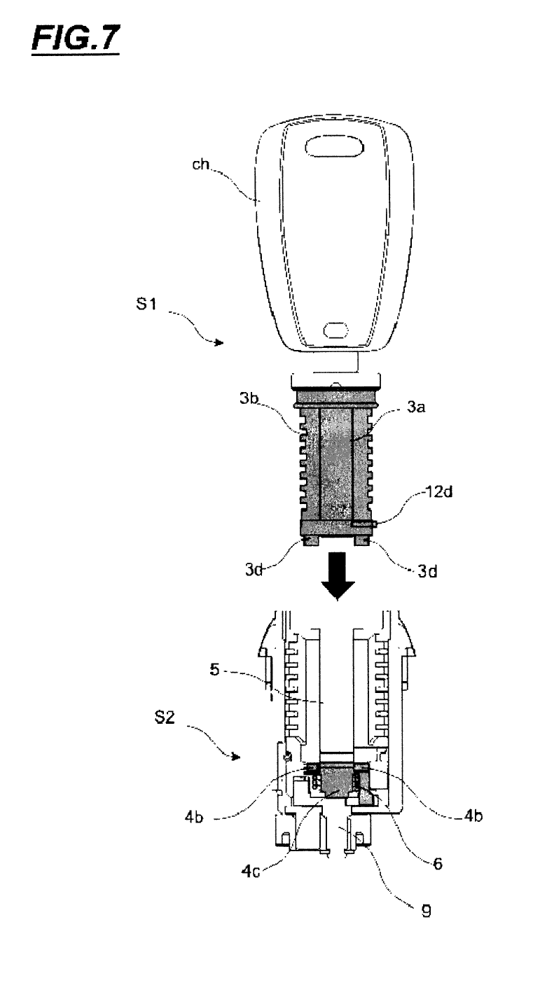

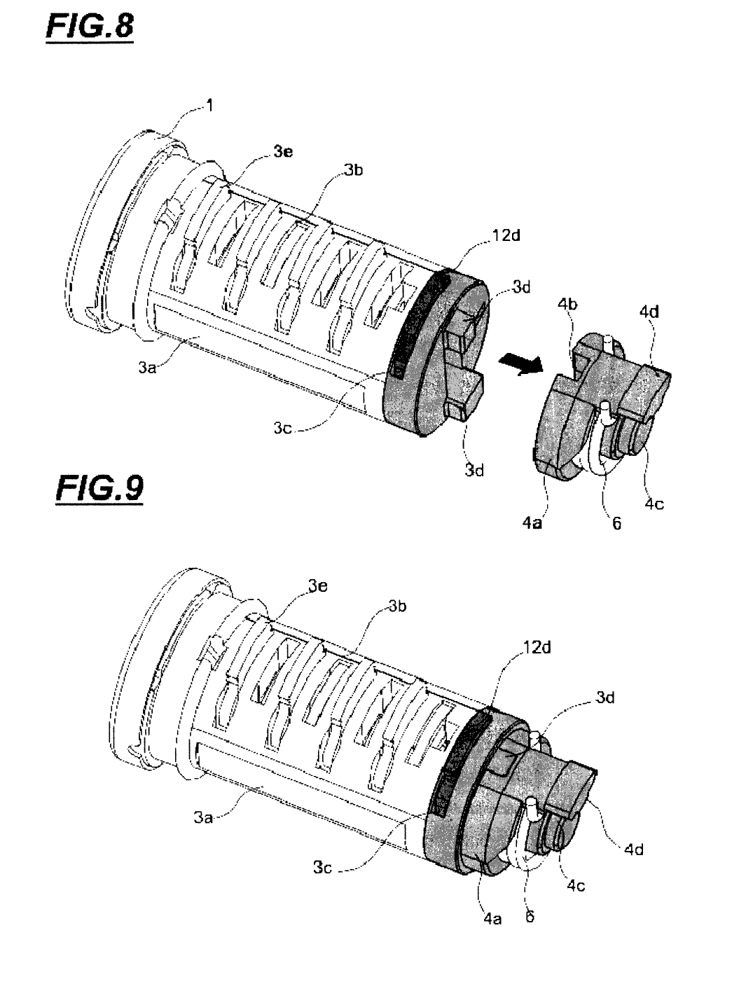

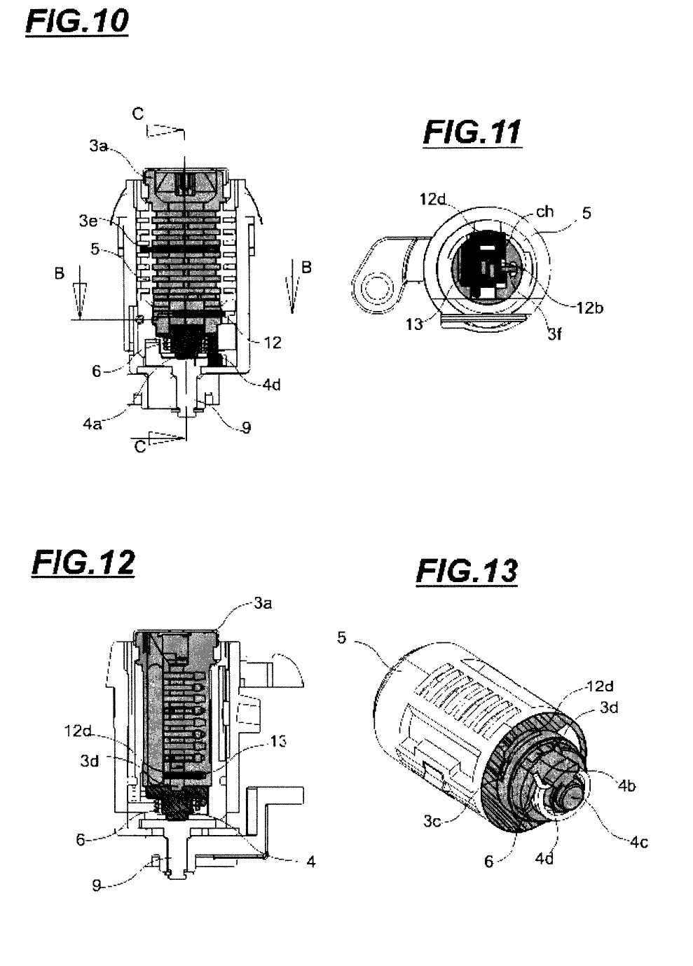

b. Free-turning anti-theft combination (S2): such as revealed through FIGS. 1, 4, 7, 10, 11, 12 and 13 respectively, where inside the outer shell (11) there is mounted the cylindric intermediary shell (5), on the rear part of which there is defined an edge (5a) to which there is already defined the assembly on its outer wall of the linear spring (7) and free-turning lock (8) components, and on the inner rear end part of this intermediary shell (5) and this subcombination differs in that it has mounted on its inside the unprecedented cylinder terminal (4), composed of a monolithic body (4a) whose front face has two chapels (4b) with the function of providing coupling of the protrusions (3d) defined on the rear end of the cylinder (3), and in turn on its rear face, see FIGS. 8 and 9 respectively, there is defined the cylinder body (4c) whose function lies in receiving the assembly of the helical spring (6), where in complement there is defined a side protrusion (4d) whose function lies in providing interference with the actuator pin component (9), see FIGS. 7 and 10 respectively.

### Assembly Procedure:

1. Assembly of the cylinder terminal component (4): preliminarily the assembler receives the free-turning anti-theft subcombination (S2) duly assembled, with the cylinder terminal component (4) mounted on the bottom of the intermediary cylinder (5), where the helical spring (6) is mounted on its cylinder body (4c) and the side protrusion (4d) is also mounted on the actuator pin component (9),

2. Assembly of the cylinder with key subcombination (S1) on the free-turning anti-theft subcombination (S2): is described by the movement of introducing the cylinder (3) inside the intermediary shell (5), see FIG. 7, where in this condition the locking face (12d) of the lock (12) interferes with this inner wall, being displaced to the inside of the cylinder (3), where this displacement movement of the lock (12) leads to the displacement of the protrusion (12c) which in turn tensions the spring (13), thus driving the lock return device.

Next, the protrusions (3d) disposed on the rear part of the cylinder (3) are coupled to the chapels (4b), guaranteeing a perfect fit between the two subcombinations, as revealed in FIGS. 8 and 9 respectively.

3. Consolidation of the assembly: lastly, to consolidate the assembly, the assembler slides the cylinder with key subcombination (S1) to the bottom of the intermediary shell (5), whereupon at the end of this movement, the rear slit (3c) reaches the point of alignment with the edge region (5a) of this shell (5), wherein this condition means there no longer exists the compression of the locking face (12d) with its inner wall, and thus the lock (12) is free, returning to its original position thanks to the tensioning effect of the spring (13). Accordingly, when the locking face (12d) returns to the outside of the rear slit (3c) the cylinder with key subcombination (S1) is locked with the free-turning anti-theft subcombination (S2): by means of interference of this locking face (12d) with the edge (5a) of the intermediary shell (5), see FIG. 13 preventing its return because once in this position it is no longer possible to retreat said locking face by the simple fact that there is no access to this locking region.

The preferred embodiment described above for the cylinder with key subcombination (S1) and the free-turning anti-theft subcombination (S2) is only provided as an example. Alterations, modifications and variations can be introduced for particular embodiments by those skilled in the art without straying from the scope of the patent, which is exclusively defined by the claims appended hereto.

1. Interchangeable system of cylinder combination with embedded key in door lock (side/trunk) equipped with automobile vehicle free-turning anti-theft device, where an automobile vehicle door lock equipped with a free-turning anti-theft device is formed basically by an intermediary shell (5), inside of which there is mounted a cylinder (3) equipped with a plurality of gorges (3e), springs and a lock (3f) for these springs; the front part of which has a lid provided with a slit for access of the lock/unlock key (ch) of the door; a helical spring (6); a free-turning device, formed by a linear spring (7) and a free-turning lock (8); an actuator (9), or eccentric component; wherein said intermediary shell (5) is mounted inside an outer shell (11), where the entire combination is fixed by an assembly lock (10), wherein this combination, notably the actuator pin (9), receives the assembly of a drive lever (14), where the interchangeable system is characterized by being comprised of a cylinder with key subcombination (S1), formed by the cylinder component (3) the rear part of which is truncated and equipped with protrusions (3d) that fit to the new cylinder terminal component (4), which is mounted on the rear part of the intermediary shell (5), also having a rear slit (3c) through which passes the locking face (12d) of a lock (12) which presents a laminar body (12a) with a side defined by a side protrusion (12c), said protrusion providing rest for the lower end of a spring (13), which in turn has its upper end limited by the inner wall of the body (3a) of the cylinder (3) and there is also a chapel (12b) on the other side through which passes the linear lock (3f); free-turning anti-theft subcombination (S2), formed by the outer shell (11) inside of which there is mounted an intermediary shell (5), having on its rear part a cylinder terminal (4), composed of a monolithic body (4a) whose front face has two chapels (4b) and on its rear face there is defined the cylinder body (4c) where there is mounted helical spring (6), and also a side protrusion (4d) connected to the actuator pin component (9).

2. Interchangeable system of cylinder combination with embedded key in door lock (side/trunk) equipped with automobile vehicle free-turning anti-theft device, according to claim 1, where the cylinder with key subcombination (S1) mounted to the free-turning anti-theft subcombination (S2) is characterized by the coupling of the protrusions (3d) disposed on the rear part of the cylinder (3) on the chapels (4b), by the rear slit (3c) of the body (3a) of the cylinder (3) is external and adjacent to the edge (5a) of the intermediary shell (5), with the locking face (12d) protruding and interfering with this edge (5a).

3. Interchangeable system of cylinder combination with embedded key in door lock (side/trunk) equipped with automobile vehicle free-turning anti-theft device, according to claim 2, wherein for the start of assembly of the cylinder (3) inside the intermediary shell (5) the lock (12) is characterized by having its locking face (12d) retreated in relation to the slit (3c) and interfering with the inner wall of the intermediary shell (5) where the spring (13) describes a compression position.

4. Interchangeable system of cylinder combination with embedded key in door lock (side/trunk) equipped with automobile vehicle free-turning anti-theft device, according to claim 2, wherein for the end of the assembly of the cylinder (3) inside the intermediary shell (5) the lock (12) is characterized by having its locking face (12d) protruding in relation to the slit (3c) and interfering with the rear edge (5a) of the intermediary shell (5) where the spring (13) describes a position of expansion.
